(19) United States
(12) Patent Application Publication
(10) Pub. No.: US 2004/0043144 A1
(43) Pub. Date: Mar. 4, 2004

(54) Method and composition for cutting dry fabric

(76) Inventors: Jeffrey Thomas Carter, Cleveland (GB); Carmelo Lofaro, San Giovanni la Punta (IT)

Correspondence Address: Fran S Wasserman, 1937 West Main Street, PO Box 60, Stamford, CT, 06904, US

(21) Appl. No.: 10/432,457

(22) PCT Filed: Nov. 5, 2001
(86) PCT No.: PCT/US01/46404

(30) Foreign Application Priority Data
Nov. 21, 2000 (GB) 0028342.4

(51) Int. Cl. B05D 3/12; B05D 1/12; B05D 1/02; C08K 3/40

(52) U.S. Cl. 427/180; 427/289; 427/421; 524/494

(57) ABSTRACT

A method for cutting fabric comprising dispensing a trace of a resin composition on the fabric surface to provide a desired fabric cutting line for cutting the fabric along the trace of dispensed resin with cutting means, wherein the resin composition is stable under dispensing and cutting conditions and is characterised by a viscosity in the range 2000-1 Pa.s (18° C.) and tack or softening at ambient or elevated temperature in the range 20 to 130° C.; a resin composition for use in the method comprising at least one substantially stable resin in substantial absence or any curing agent, catalyst or cross linking agen characterised by viscosity in the range 2000-1 Pa.s (18° C.) and tack or softening at ambient and/or elevated temperature; method for the preparation thereof; a method for blending thereof; apparatus for use in the method; a method for dry fibre moulding using the method and composition; a preform obtained with use of the method and composition; a method for injecting or infusing the preform with curable matrix resin: the curable injected or infused preform resin; a method for curing thereof; and a cured composite obtained with the method.

The present invention relates to a method for preparing fabric for cutting, and cutting thereof, a resin composition for use in cutting fabrics, and cut fabrics. More particularly the invention relates to a method for preparing and cutting fabric using a resin composition to tack the cut edges, the resin composition for use in preparing and cutting the fabric and cut fabric.

Composites are used as engineering grade polymers in the construction of load bearing articles, typically in marine, automotive, aerospace and construction industries, such as storage vessels, transportation containers, vehicle parts including cars, trucks, boats, aeroplanes, trains and the like. The composites comprise fibrous reinforcement such as glass fibres, carbon fibres etc, and a cured resin.

Composites are traditionally made from prepregs of fibre impregnated with a matrix resin of combined thermoplast resin and thermosetting resin which are laid up, moulded and laminated. Prepreg properties and quality are controlled for toughness, strength, flexibility and the like. Sheets of prepreg may be cut to size for laying up and moulding in the construction of a given article.

More recently composites are made by various dry moulding processes in which dry fibres are first arranged in a mould as a perform and then injected or infused directly in-situ with matrix resins. The preform comprises fibres placed in the mould as a fibre form of one or a plurality of plies or layers of fibrous material, cut and laid up with desired fibre orientation to form the required shape and held in place by stitching, weaving, braiding, stapling or bonding using binders.

Dry fibre moulding processes necessitate the cutting of dry fabric or fibres to size and/or shape. One technique employs an ultrasonic cutting tip operating at very high frequency for example 68,000 vibrations per second. This has been found to cut fabrics efficiently and cleanly. Unfortunately, the fabric loses its integrity at the cut edge and as a result individual fibres tend to loosen, whereby the border region of the fabric tends to lose alignment, density and form in general. This presents an insurmountable problem, whereby the fabrics cannot be used in the preparation of finished parts, since the borders or edges of the articles are sub-standard in terms of properties, and quality and unsuited for joining, together with other parts in a finished product.

Currently the solution to the problem requires oversized cutting and moulding of fabric and cutting the moulded part to shape and size. This introduces difficulties in accuracy of shaping and sizing articles and is laborious and time consuming.

Heat sealing of polymer fabrics and ropes is known in the art, and typically comprises heating and softening a resin fabric or rope which binds the edges together to seal or prevent unravelling. In such cases, the seal is formed of the molten polymer forming the fabric itself, as distinct from a dedicated sealant and is chemically changed on heating, forming a rigid, brittle seal on cooling.

Sealing with an adhesive may also be known in the art, however, adhesives are thermally or chemically reactive and are typically formulated to have a viscosity adapted for accurate dispensing, without permeating or wicking into a material onto which they are dispersed. Since fabrics unravel or loosen at the time of cutting, in-situ sealing is required. Such adhesives therefore, although suited for sealing a pre-cut fabric, would be unsuitable for an ineffective in-situ sealing of a fabric, simultaneous with cutting.

Accordingly there is a need for an alternative approach to preparation of dry fabrics for moulding. We have now surprisingly found that a novel preparation and cutting method using a resin composition as a cutting aid for dry fabrics in particular manner increases the accuracy of the fabric cutting and shaping, and moreover does not interfere with the subsequent matrix resin injection process in constructing composites of preforms or prepregs, and the properties of a finished product.

Accordingly in the broadest aspect of the invention there is provided a method for preparing fabric comprising dispensing a trace of a resin composition on the fabric surface to provide a desired fabric cutting line for cutting the fabric along the trace of dispensed resin with cutting means, wherein the resin composition is stable under ambient or elevated temperature dispensing and cutting conditions and is characterised by a viscosity in the range 2000-1 Pa.s (18° C.) and tack or softening at ambient and/or elevated temperature.

Suitably the method comprises dispensing a composition comprising at least one resin component which is substantially unchanged after subjecting to dispensing and cutting conditions, and reverts to its resin form. Preferably the method comprises dispensing a resin composition comprising substantially no curing agent, catalyst or cross linking agent which would be activated by the dispensing or curing conditions.

It is a particular advantage of the invention that the resin composition is thermally stable under both the dispensing and cutting conditions, i.e. is substantially unchanged on heating to elevated temperature. More preferably the resin is thermally stable at least up to a temperature at which it is characterised by moderate tack, adapted to tack together fabric at its edges.

Preferably the method of the invention comprises laying up fabric for cutting on a suitable surface such as a cutting table, pre-tracing a shape to be cut with a suitable marker, dispensing resin composition as hereinbefore defined and cutting, or storing for later cutting.

Preferably dispensing conditions according to the method of the invention comprises preheating the resin to a melt prior to dispensing, or heating in situ, to generate the resin in melt form at a temperature dependent on the nature of the resin components. Preferably the resin is provided in melt form at ambient or elevated temperature in the range 20-130° C., more preferably 20-70° C. Alternatively the resin may be dispensed as a powder or film and heated to molten, or may be dispensed as a spray. The resin is characterised by tack in molten or spray form and adheres fabric prior to cutting.

After cooling the trace of resin is followed with a cutting means as hereinbefore defined. Cutting may be immediately following trace dispensing or at a later stage thereafter. Preferably trace dispensing and cutting are performed in immediate succession in a combined operation for accuracy of following resin trace with the cutting means.

Suitably cutting conditions according to the method comprises contact or incidence by cutting means of the molten or cooled resin trace, preferably of the trace cooled to ambient temperature. The thermally stable composition regains substantially all properties of the resin on cooling, whereby it may be readily cut by the cutting means. Contact or incidence of cutting means may generate insignificant energy and no temperature increase or may generate substantial energy causing localized temperature elevation of the resin trace. For example ultrasonic cutting operates at high cutting frequency and provides excellent quality of cut but causes localized elevated temperature. In a particular advantage, high frequency or high speed cutting substantially avoids rein adhering to the cutting blade. Cutting means may be any suitable means selected from a laser or cutting blade such as an advancing blade. Preferably cutting means comprise an ultrasonic tip operating at high cutting frequency for example 68,000 vibrations per second and using a diamond, graphite or steel tip. Ultrasonic tips are known for example commercially available (GFM Aktiengesellschaft, Gerber Garment Technology Inc. etc) or as disclosed in U.S. Pat. No. 5,318,420, U.S. Pat. No. 4,596,171, U.S. Pat. No. 4,373,412 and U.S. Pat. No. 3,495,492. Preferably a cutting surface comprises a soft bench for example of expanded poly vinyl which is adapted to be penetrated by a cutting means thereby giving a clean fabric cut. Preferably cutting is performed under vacuum to aid in maintaining the positioning of the fabric during cutting, more preferably with use of an airwave to assist in vacuum control.

The method of the invention may be for cutting fabrics for any desired purpose and it is preferably for cutting fabric for dry moulding in the construction of a composite material. In a particular advantage the method of the invention is used for cutting any fabric which is prone to disassemble, disintegrate, or otherwise form rough or loose edges on dry cutting.

Reference herein to a fabric is typically to directional or non-directional aligned fibres in the form of a mesh, tow, scrim, braided or woven, knitted, non-crimped fabrics and the like. Fabrics may be available commercially in any of the above forms or may be prepared specifically for a given use. Commercial or otherwise prepared fabrics which may be cut using the method of the invention may be of any desired density and are typically of density or aerial weight in the range of 200-2000g/m², preferably 400-1600 g/m², more preferably 400-1200 g/m². Particular advantages are obtained with heavy fabrics in the range 1000-1600 g/m². Fabric density may vary as a function of fibre thickness or packing density of fibres.

Fabric may be of any desired thickness for the suited purpose and is suitably of thickness in the range 0.2-10 millimetres, either as a single fabric layer or a plurality of assembled layers.

The fibre comprised in the fabric may be any organic or inorganic fibres and mixtures thereof. Organic fibres are selected from tough or stiff polymers such as polyester, polyaromatic or poly paraphenylene terephthalamide. Among inorganic fibres carbon, boron or glass fibres such as “E” or “S” can be used, or alumina, zirconia, silicon carbide, other compound ceramics or metals. A very suitable reinforcing fibre is carbon, for example as graphite. Graphite fibres which have been found to be especially useful in the invention are those supplied by Amoco under the trade designations T650-35, T650-42 and T300; those supplied by Toray under the trade designation T800-HB; and those supplied by Hercules under the trade designations AS4, AU4, IM 8 and IM 7.

Organic or carbon fibre is preferably unsized or is sized with a material that is compatible with the composition according to the invention, in the sense of being soluble in the liquid precursor composition without adverse reaction or of bonding both to the fibre and to the thermoset/thermoplastic composition according to the invention. In particular carbon or graphite fibres that are unsized or are sized with epoxy resin precursor or thermoplast such as polyarylsulphone are preferred. Inorganic fibre preferably is sized with a material that bonds both to the fibre and to the polymer composition; examples are the organo-silane coupling agents applied to glass fibre.

The resin composition for use in cutting fabric according to the method of the invention may be any suitable resin composition which is characterised by suitable properties of viscosity and tack for permeation and controlled penetration and tack of cut ends of fabric and having properties of flexibility to allow fabric conformation without tearing or cracking and which allows passage of preform binder resin and matrix resin in subsequent resin moulding, and does not affect the finished product properties.

The resin composition is preferably characterised by temperature independent viscosity or partially dependent viscosity whereby viscosity is substantially unchanged or decreases in the above defined range both on heating to a resin melt, and on contact or incidence of the cutting means. It will be appreciated that the resin melt provides tack to adhere cut ends of fabric as hereinbefore defined. It is therefore important that the resin melt is not able to penetrate the fabric to contact an opposing surface on which the fabric is laid up for cutting, whereby it may contaminate the cutting surface. It is also important that the resin melt does not adhere to the cutting means. Contamination of the cutting surface or cutting means can result in undesired adhesion of the fabric which may loosen or remove fibres from the fabric on withdrawal of the fabric from the cutting surface or blade or from a stack of cut fabrics or the like. Contamination of the cutting surface can also damage the cutting means.

Preferably the composition comprises in combination a plurality of resin components selected by nature, and number average molecular weight (Mn) and ratio of thermoplast to thermoset to achieve a desired viscosity as hereinbefore defined for a particular fabric which it is desired to cut, whereby the resin permeates the fabric surface and optionally partially penetrates the fabric.

Preferably the resin composition viscosity and/or dispensing rate is selected to provide a steady slow flow front on dispensing, serving to “meter” resin, filling all cavities rather than by passing the fabric.

A trace of resin composition, dispensed according to the method as hereinbefore defined may be any suitable line, band, track or the like of sufficient width to follow with a cutting means in manner that the cutting means only contacts fabric within the trace. Broader trace width may be employed but is likely to be detrimental to the subsequent infusion or injection, and involves needless additional use of resin. Preferably the trace width is as small as possible, for example in the range 0.2-20 millimetre (200-20,000 micron). Preferably the method ensures accurate and precise dispensing and cutting, and employs a fine cutting means whereby trace width is in the range 200-500 micron.

Preferably the resin is “metered” to provide a trace penetration within the thickness of the fabric, in sufficient resin quantity to tack the cut ends of the fabric. Trace depth or penetration depth may be up to 99% of the fabric thickness and is preferably 40-90% of the fabric thickness. Penetration may take place on dispensing and prior to cooling, and/or on cutting. A penetration in the range 0.1-4 millimetres prior to cooling may be employed for low or high density, thin or thick fabrics and is obtained by suitable adjustment of the resin composition, for example increasing the quantity of thermoplast to reduce penetration.

Methods for selecting and optimising viscosity and flow control are known in the art, and suitably the viscosity is measured for a range of compositions, in each case varying the temperature and subjecting to a standard shear. From the results a composition may be selected or a melt dispensing temperature selected for a given composition, to suit a particular fabric thickness and density which it is desired to cut.

Preferably resin composition is at least partially temperature dependent and undergoes temperature increase on cutting which serves to increase tack and adhere the cut ends of the fabric. It will be appreciated that the resin composition is however thermally stable and that it does not cure as a result of the temperature increase on dispensing or cutting. It is a further advantage that the thermally stable resin composition used in the method of the invention allows a greater flexibility in temperature control during dispensing and subsequent cutting without the risk of inadvertent curing thereof. This has been found to be particularly useful in that any leaked resin composition does not contaminate the cutting bench by forming hard deposits which may break a cutting blade on impact, moreover does not form hard deposits within a fabric which may impede injection or infusion of preform binder or matrix resin.

After cutting, the cut fabric may be stored or placed in a mould for subsequent processing into an article.

The resin preferably maintains tack for the duration of any storage period, for example for a number of days, preferably at least 48 hours. It is a particular advantage that the resin composition employed in the method of the invention is characterised by moderate tack that is effective to be an aid in the lay up process. Accordingly the cut fabric may be laid up with other layers of fabric and/or laid up in a mould within a few days of cutting, and the residual tack from the cut edges used to assist in maintaining the positioning of the fabric by non contaminating tack to the adjacent fabric layer(s) or mould surface. Since the resin composition is tacky and not adhesive, it leaves no residue and repositioning or removal present no problems.

In a further aspect of the invention there is provided a resin composition as hereinbefore defined for use in a method for cutting fabrics as hereinbefore defined comprising at least one substantially stable resin characterised by viscosity in the range 2000-1 Pa.s (18° C.) and tack or softening at ambient and/or elevated temperature. Suitably a composition is thermally and/or chemically stable as hereinbefore defined, preferably is substantially unchanged after subjecting to dispensing and cutting conditions, and reverts to its resin form. Preferably the resin composition comprises substantially no curing agent, catalyst or cross linking agent which would be activated by the dispensing or curing conditions, more preferably comprises the composition is in substantial absence of any curing agent, catalyst or cross linking agent.

Suitably the resin composition for use in the method of the invention comprises a thermoplastic resin and a thermosetting resin in ratio 40:60-5:95, preferably in ratio 30:70-5:95, more preferably in ratio 20:80-5:95, for example 15:85-10:90. It will be appreciated that the ratio of components may be selected according to the nature thereof.

In a particular advantage of the invention we have found that the combination of thermoplast and thermoset may operate with synergistic effect having regard to the viscosity and flexibility of the combined blend. Suitably the thermoplastic resin serves to provide flow control for the blend, dominating the typically low viscosity thermoset, and to flexibilise the blend, dominating the typically brittle thermoset and the thermoset resin provides tack. This enables the contact, controlled penetration and adhesion of fabric, and flexibility of the cut fabric to allow fabric conformation, for example in shaping in the mould, without tearing or cracking of the tacked edges. Should some leakage occur, it is an advantage of the present invention that the chemically inert tacky resin does not leave a permanent residue and may be simply removed.

Suitably the thermoplast resin component is selected from at least one of the group of polyaromatics such as polyaryl(thio)ethers and in particular polysulphones, heterocyclic aromatic polymers such as polyimides and polyetherimides, polyamides such as nylon, polyesters such as ethan-1,2-diol PET and PEN, polyurethanes such as thermoplastic polyurethane rubber, polyvinylalcohols and copolymers of the above.

Preferably polyarylethers comprise ether linked phenyl units and ether linked arylsulphone units and reactive end groups, more preferably of the class polyethersulphone:polyetherethersulphone (PES:PEES).

Preferably the thermoplast resin component comprises at least one polyaromatic comprising repeating units of the formula

-R-Ph-A-Ph-R-

wherein each A independently is selected from a direct link, SO₂, oxygen, sulphur, —CO— or a divalent hydrocarbon radical;

R is any one or more substituents of the aromatic rings, each independently selected from hydrogen, C₁₋₈ branched or straight chain aliphatic saturated or unsaturated aliphatic groups or moieties optionally comprising one or more heteroatoms selected from O, S, N, or halo for example Cl or F; and groups providing active hydrogen especially OH, NH₂, NHR— or —SH, where R- is a hydrocarbon group containing up to eight carbon atoms, or providing other cross-linking activity especially epoxy, (meth) acrylate, cyanate, isocyanate, acetylene or ethylene, as in vinyl, allyl or maleimide, anhydride, oxazoline and monomers containing saturation; and

wherein said at least one polyaromatic comprises reactive pendant and/or end groups.

Preferably the at least one polyaromatic comprises at least one polyaryl sulphone comprising ether-linked and/or thioether-linked repeating units, the units being selected from the group consisting of

-(PhAPh)ₙ-

and optionally additionally

-(Ph)ₐ-

wherein A is SO₂ or CO, Ph is phenylene, n=1 to 2, a=1 to 4 and when a exceeds 1, said phenylenes are linked linearly through a single chemical bond or a divalent group other than -A- or are fused together directly or via a cyclic moiety such as a cycloalkyl group, a (hetero) aromatic group, or cyclic ketone, amide, amine, or imine, said at least one polyarylsulphone having reactive pendant and/or end groups.

More preferably the at least one polyaromatic comprises at least one polyaryl sulphone comprising ether-linked repeating units, optionally additionally comprising thioether-linked repeating units, the units being selected from

-(PhSO₂Ph)ₙ-

and optionally additionally

-(Ph)ₐ-

wherein Ph is phenylene, n=1 to 2 and can be fractional, a=1 to 3 and can be fractional and when a exceeds 1, said phenylenes are linked linearly through a single chemical bond or a divalent group other than —SO₂— or are fused together, provided that the repeating unit -(PhSO₂Ph)ₙ- is always present in said at least one polyarylsulphone in such a proportion that on average at least two of said units -(PhSO₂Ph)ₙ- are in sequence in each polymer chain present, said at least one polyarylsulphone having reactive pendant and/or end groups.

Preferably the polyaromatic comprises polyether sulphone, more preferably a combination of polyether sulphone and of polyether ether sulphone linked repeating units, in which the phenylene group is meta- or para- and is preferably para and wherein the phenylenes are linked linearly through a single chemical bond or a divalent group other than sulphone, or are fused together. By “fractional” reference is made to the average value for a given polymer chain containing units having various values of n or a.

Additionally, as also discussed, in said at least one polyarylsulphone, the relative proportions of the said repeating units is such that on average at least two units (PhSO₂Ph)ₙ are in immediate mutual succession in each polymer chain present and is preferably in the range 1:99 to 99:1, especially 10:90 to 90:10, respectively. Typically the ratio is in the range 25-50 (Ph)ₐ, balance (Ph So₂Ph)ₙ. In preferred polyarylsulphones the units are:

XPhSO₂PhXPhSO₂Ph(“PES”) and 1

X(Ph)ₐXPhSO₂Ph(“PES”) 11

where X is O or S and may differ from unit to unit; the ratio is 1 to 11 (respectively) preferably between 10:90 and 80:20 especially between 10:90 and 55:45.

The preferred relative proportions of the repeating units of the polyarylsulphone may be expressed in terms of the weight percent SO₂ content, defined as 100 times (weight of SO₂)/(weight of average repeat unit). The preferred SO₂ content is at least 22, preferably 23 to 25%. When a=1 this corresponds to PES/PEES ratio of at least 20:80, preferably in the range 35:65 to 65:35.

The above proportions refer only to the units mentioned. In addition to such units the polyarylsulphone may contain up to 50 especially up to 25% molar of other repeating units: the preferred SO₂ content ranges (if used) then apply to the whole polymer. Such units may be for example of the formula

Ph-A-Ph

as hereinbefore defined, in which A is a direct link, oxygen, sulphur, —CO— or a divalent hydrocarbon radical. When the polyarylsulphone is the product of nucleophilic synthesis, its units may have been derived for example from one or more bisphenols and/or corresponding bisthiols or phenol-thiols selected from hydroquinone, 4,4′-dihydroxybiphenyl, resorcinol, dihydroxynaphthalene (2,6 and other isomers), 4,4′-dihydroxybenzophenone, 2,2′-di(4-hydroxyphenyl)propane and -methane.

If a bis-thiol is used, it may be formed in situ, that is, a dihalide as described for example below may be reacted with an alkali sulphide or polysulphide or thiosulphate.

Other examples of such additional units are of the formula

-Ph-Q(Ar-Q′)ₙ-Ph-

in which Q and Q′, which may be the same or different, are CO or SO2; Ar is a divalent aromatic radical; and n is 0, 1, 2, or 3, provided that n is not zero where Q is SO2. Ar is preferably at least one divalent aromatic radical selected from phenylene, biphenylene or terphenylene. Particular units have the formula

-Ph-Q-[-(-Ph-)ₘ-Q′-]ₙ-Ph-

where m is 1, 2 or 3. When the polymer is the product of nucleophilic synthesis, such units may have been derived from one or more dihalides, for example selected from 4,4′-dihalobenzophenone, 4,4′ bis(4-chlorophenylsulphonyl)biphenyl, 1,4,bis(4-halobenzoyl)benzene and 4,4′-bis(4-halobenzoyl)biphenyl.

They may of course have been derived partly from the corresponding bisphenols.

The polyaromatic may be the product of nucleophilic synthesis from halophenols and/or halothiophenols. In any nucleophilic synthesis the halogen if chlorine or bromine may be activated by the presence of a copper catalyst.

Such activation is often unnecessary if the halogen is activated by an electron withdrawing group. In any event fluoride is usually more active than chloride. Any nucleophilic synthesis of the polyaromatic is carried out preferably in the presence of one or more alkali metal salts, such as KOH, NaOH or K₂CO₃ in up to 10% molar excess over the stoichiometric.

As previously mentioned, said at least one polyaromatic contains reactive end groups and/or pendant groups. End groups may be obtained by a reaction of monomers or by subsequent conversion of product polymers prior to or subsequently to isolation. Preferably groups are of formula -A′-Y where A′ is a divalent hydrocarbon group, preferably aromatic, and Y is a group reactive with epoxide groups or with curing agent or with like groups on other polymer molecules. Examples of Y are groups providing active hydrogen especially OH, NH₂, NHR′ or —SH, where R′ is a hydrocarbon group containing up to 8 carbon atoms, or providing other cross-linking reactivity especially epoxy, (meth)acrylate, cyanate, isocyanate, acetylene or ethylene, as in vinyl, allyl or maleimide, anhydride, oxazaline and monomers containing saturation. Preferred end groups include amine and hydroxyl.

The number average molecular weight of the polyaromatic is suitably in the range 2000 to 20000. A useful sub-range is over 3000, especially in the range of 3000 to 11000, for example 3000 to 9000.

Thermoset resin components may be selected from the group consisting of an epoxy resin, an addition-polymerisation resin, especially a bis-maleimide resin, a formaldehyde condensate resin, especially a formaldehyde-phenol resin, a cyanate resin, an isocyanate resin, a phenolic resin and mixtures of two or more thereof, and is preferably an epoxy resin derived from the mono or poly-glycidyl derivative of one or more of the group of compounds consisting of aromatic diamines, aromatic monoprimary amines, aminophenols, polyhydric phenols, polyhydric alcohols, polycarboxylic acids and the like, or a mixture thereof, a cyanate ester resin or a phenolic resin. Examples of addition-polymerisation resins are acrylics, vinyls, bis-maleimides, and unsaturated polyesters. Examples of formaldehyde condensate resins are urea, melamine and phenols.

Preferably the thermoset resin component comprises at least one epoxy, cyanate ester or phenolic resin precursor, which is liquid at ambient temperature for example as disclosed in EP-A-0 311 349, EP-A-0 365 168, EPA 91310167.1 or in PCT/GB95/01303. Preferably the thermoset is an epoxy resin.

An epoxy resin may be selected from N,N,N′N′-tetraglycidyl diamino diphenylmethane (eg “MY 9663”, “MY 720” or “MY 721” sold by Ciba-Geigy) viscosity 10-20 Pa s at 50° C.; (MY 721 is a lower viscosity version of MY720 and is designed for higher use temperatures); N,N,N′,N′-tetraglycidyl-bis(4-aminophenyl)-1,4-diiso-propylbenzene (eg Epon 1071 sold by Shell Chemical Co) viscosity 18-22 Poise at 110° C.; N,N,N′,N′-tetraglycidyl-bis(4-amino-3,5-dimethylphenyl)-1,4-diisopropylbenzene, (eg Epon 1072 sold by Shell Chemical Co) viscosity 30-40 Poise at 110° C.; triglycidyl ethers of p-aminophenol (eg “MY 0510” sold by Ciba-Geigy), viscosity 0.55-0.85 Pa s at 25° C.; preferably of viscosity 8-20 Pa at 25° C.; preferably this constitutes at least 25% of the epoxy components used; diglycidyl ethers of bisphenol A based materials such as 2,2-bis(4,4′-dihydroxy phenyl) propane (eg “DE R 661” sold by Dow, or “Epikote 828” sold by Shell), and Novolak resins preferably of viscosity 8-20 Pa s at 25° C.; glycidyl ethers of phenol Novolak resins (eg “DEN 431” or “DEN 438” sold by Dow), varieties in the low viscosity class of which are preferred in making compositions according to the invention; digylcidyl 1,2-phthalate, eg GLY CEL A-100; diglycidyl derivative of dihydroxy diphenyl methane (Bisphenol F) (eg “PY 306” sold by Ciba Geigy) which is in the low viscosity class. Other epoxy resin precursors include cycloaliphatics such as 3′,4′-epoxycyclohexyl-3,4-epoxycyclohexane carboxylate (eg “CY 179” sold by Ciba Geigy) and those in the “Bakelite” range of Union Carbide Corporation.

A cyanate ester resin may be selected from one or more compounds of the general formula NCOAr(YₓArₘ)_{q}OCN and oligomers and/or polycyanate esters and combinations thereof wherein Ar is a single or fused aromatic or substituted aromatics and combinations thereof and therebetween nucleus linked in the ortho, meta and/or para position and x=0 up to 2 and m and q=0 to 5 independently. The Y is a linking unit selected from the group consisting of oxygen, carbonyl, sulphur, sulphur oxides, chemical bond, aromatic linked in ortho, meta and/or para positions and/or CR₁R₂ wherein R₁ and R₂ are hydrogen, halogenated alkanes, such as the fluorinated alkanes and/or substituted aromatics and/or hydrocarbon units wherein said hydrocarbon units are singularly or multiply linked and consist of up to 20 carbon atoms for each R₁ and/or R₂ and P(R₃R4R′₄R₅) wherein R₃ is alkyl, aryl, alkoxy or hydroxy, R′₄ may be equal to R4 and a singly linked oxygen or chemical bond and R₅ is doubly linked oxygen or chemical bond or Si(R₃R₄R′₄R₆) wherein R₃ and R₄, R′₄ are defined as in P(R₃R4R′₄R₅) above and R₅ is defined similar to R3 above. Optionally, the thermoset can consist essentially of cyanate esters of phenol/formaldehyde derived Novolaks or dicyclopentadiene derivatives thereof, an example of which is XU71787 sold by the Dow Chemical Company.

A phenolic resin may be selected from any aldehyde condensate resins derived from aldehydes such as methanal, ethanal, benzaldehyde or furfuraldehyde and phenols such as phenol, cresols, dihydric phenols, chlorphenols and C₁₋₉ alkyl phenols, such as phenol, 3- and 4-cresol (1-methyl, 3- and 4-hydroxy benzene), catechol (2-hydroxy phenol), resorcinol (1,3-dihydroxy benzene) and quinol (1,4-dihydroxy benzene). Preferably phenolic resins comprise cresol and novolak phenols.

The thermoset resin component is suitably the product of at least partly curing a resin precursor using a curing agent and optionally a catalyst.

The weight proportion of thermoplast component in the composition is typically in the range 5 to 40%, preferably 5 to 30%, especially 5 to 20%, for example 10 to 15%.

The resin composition comprises at least one resin component as hereinbefore defined and preferably comprises resin components which are compatible with a matrix resin to be used in the subsequent molding. More preferably the resin composition comprises in combination a thermoplastic resin and a thermosetting resin, most preferably comprises thermoplast selected from polyaromatic in combination with thermoset selected from cyanate ester, bismaleimide or epoxy in the range 20:80-5:95. More preferably the composition comprises as polyaromatic a polysulphone having up to 25% of added monomers, more preferably comprising polyethersulphone: polyetherethersulphone in the ratio 90:10-10:90, more preferably 60:40-50:50, and optionally comprising up to 25% of added monomers such as biphenyl. The preferred composition has been found to have excellent viscosity control, thermal stability and conferred flexibility. The resin component ratio may be tailored to a desired viscosity window.

In a further aspect of the invention there is provided a method for the preparation of a resin composition as hereinbefore defined comprising admixing the resin components, optionally in the presence of solvent and/or warming to a temperature of up to 80° C., with subsequent removal of solvent and cooling. When the composition is in liquid or spray form the resin components are suitably dissolved in a solvent such as dichloromethane. When the composition is in film form the components are suitably cast onto a release surface, which may be a sheet surface suitable for cutting to a desired trace shape to be laid out on a fabric to be cut, or may be a ribbon surface suitable for laying out in a desired shape on a fabric to be cut. When the composition is in powder form the composition is suitably granulated and milled to appropriate particle size.

In a further aspect of the invention there is provided a method for selecting or blending a resin composition having desired viscosity and tack at ambient and/or elevated temperature, for dispensing on a given fabric and cutting as hereinbefore defined, comprising determining a required viscosity for penetration of the given fabric, with reference to fabric density (aerial weight) and/or thickness and selecting at least one resin component and a dispensing temperature with reference to viscosity-temperature data. Preferably the method comprises establishing viscosity-temperature data for one or more resin compositions.

In a further aspect of the invention there is provided a dispensing cutting apparatus for use in a method for cutting dry fabrics as hereinbefore defined comprising a reservoir for resin composition, a nozzle for dispensing a trace of resin and a cutting means aligned to follow the resin trace.

Preferably the reservoir comprises means for heating the resin or regulating the temperature of heated resin in the form of any melt, alternatively means for pressurising a resin in the form of a spray, alternatively means for contact heating resin in the form of a powder or film.

Preferably the nozzle and cutting means are adapted to follow a common trace, for example aligned with respect to the direction of advance of the apparatus, or including sensor or other means for guiding and locating the nozzle and cutting means. The apparatus may be programmable to trace and cut to high precision.

In a further aspect of the invention there is provided a dry fabric cut according to the method or with use of the composition or cutting means as hereinbefore defined. The cut fabric may be stored for subsequent use or may be placed in a mould for subsequent processing into an article. In a particular advantage the dry fabric comprises at least one resin trace as hereinbefore defined which may be used for positioning the fabric in preparation of a fibre form or preform for dry fibre moulding in the preparation of a composite material.

In a further aspect of the invention there is provided a method for dry fibre moulding comprising cutting a fabric using the method as hereinbefore defined, placing in a mould, optionally contacting with a binder resin for example as disclosed in copending GB 0028341.6 and injecting or infusing matrix resin.

The cut fabric of the invention is suited for production of preforms for use with a wide variety of matrix resins comprising in combination or separately a thermoplast and thermosetting resin, typically in weight ratio 10/90-90/10 such as 20/80-40/60, for example 30/70. The cutting resin is required to be chemically and physically compatible with the matrix resin to be used, preferably to be miscible, soluble and mutually compatible therewith Compatible cutting resin may comprise same or different resins and resin component to a suitable matrix resin and will be apparent to those skilled in the art. Importantly the cutting resin must not impede or interfere with the injection of matrix resin or alter the flow front in any way.

Preferred matrix resins comprise a thermoplast and thermoset, selected from components as hereinbefore defined for the cutting resin. Preferably cutting resin and matrix resin comprise thermoplast component differing only in reactive end group type, Mn and/or PES:PEES ratio, and more preferably differing only in Mn, whereby matrix resin thermoplast has Mn in the range up to 60,000, and PES:PEES ratio. Cutting resin and matrix resin may comprise thermoset resin component of different class, for example cutting resin component comprises epoxy resin and matrix resin comprises resin selected from addition-polymerisation resin, a formaldehyde condensate resin, a cyanate resin, an isocyanate resin, a phenolic resin and mixtures of two or more thereof. Preferably cutting resin and matrix resin comprise thermoset resin component of same or different resin type within same class, such as the same or different resin types as hereinbefore defined within the class of epoxy resin.

Finally cutting resin and matrix resin may comprise the same components in different relative weight ratio of thermoplast to thermoset wherein cutting resin has ratio in range 40:60-5:95, preferably in ratio 30:70-5:95, more preferably in ratio 20:80-5:95, for example 15:85-10:90 and matrix resin has ratio in range 10/90-90/10 such as 20/80-40/60, for example 30/70 as hereinbefore defined.

In a further aspect of the invention there is provided a preform or curable composition obtained with use of the cutting and moulding method of the invention, preferably comprising a non-crimped fabric.

In a further aspect of the invention there is provided a method for curing a curable composition as hereinbefore defined comprising subjecting to elevated temperature and pressure for a period suitable to effect curing thereof.

In a further aspect of the invention there is provided a composite part obtained with the method as hereinbefore defined.

The invention is now illustrated in non-limiting manner with reference to the following examples and figures.

### EXAMPLE 1

### Preparation of Resin Composition Comprising Epoxy and Polyaromatic

The resin composition was prepared by warming epoxy or epoxies, at temperature not exceeding 60° C. The polyaromatic comprising 40:60 PES:PEES copolymer with primary amine termination, 12K, was synthesised by reacting 1 mol of DCDPS with 2 moles of m-aminophenol using potassium carbonate as the catalyst and sulpholane as the reaction solvent. The polyaromatic, dissolved in a small amount of dichloromethane, was then added in an amount of from 10-20 wt %. Once the resins had been warmed and their viscosity reduced the solvent was removed at 60° C. The resin was used immediately or cooled for later use.

Compositions were studied for viscosity, permeation and tack and the results are given in Table 1.

TABLE I
Compositions studied

| PY306/ | | | | | |
|---|---|---|---|---|---|
| 40:60 | | | | | |
| PES:PEES | Eta*(Pa.s) | Eta*(Pa.s) | Solvent | | Tack at |
| ratio | @ RT | @ 50° C. | required | Permeation | 2 days |
| 60/40 | — | — | Yes | Poor | No |
| 70/30 | — | — | Yes | Fair | No |
| 80/20 | 800 | 50 | No | Fair | Yes |
| 90/10 | 40 | 3 | No | Good | Yes |

Viscosity data was obtained as a function of temperature and applied shear for two compositions and the results are given in FIGS. 1 and 2. From the data, a reference shear value of 10 rad/s was chosen at which resin performance was observed to be steady for both compositions across the entire temperature range. This data was used to optimise resin compositions and dispensing conditions for given fabrics.

### EXAMPLE 2

### Dispensing and Cutting

2-3 mm thick dry fabric (multiaxial 600 g/m²) was traced with resin compositions obtained in Example 1. The compositions were manually dispensed using a nozzle at a rate of 4-5 g/s and speed of advance of nozzle of 0.2 m/s. The fabric was allowed to stand for 2 to 3 minutes during which the melt was observed to penetrate through the fabric thickness to the opposite face, but was retained within the fabric thickness by cooling in this period. The fabric was then cut with a GFM US50 cutting machine, following the resin trace.

As a comparison the dispensing method was repeated on a similar fabric sample, reducing the dispensing rate or increasing the nozzle advance speed.

The cut fabric is shown in FIGS. 3 and 4. FIG. 3 shows excellent performance and cutting quality with no loose fibres.

FIG. 4 shows fibre loosening where cutting failed to follow the resin trace, or tack was locally ineffective due to insufficient thickness penetration.

As comparison, a similar fabric sample was cut without use of resin trace. The results are shown in FIG. 5.

### EXAMPLE 3

### Resin Film Infusion

The cut fabric of Example 2 was laid up in a mould, overlaid with binder resin and heated to infuse matrix resin comprising corresponding epoxy, polyaromatic in 60:40 ratio and curing catalysts, to form a composite part. Studies were made of resin film infusion of the resin cut fabric and the conventional cut fabric. The cutting resin was found not to impede matrix resin infusion and the finished part was of superior quality and uniformity to the conventional cut infused fabric.

### BRIEF DESCRIPTION OF FIGURES

FIGS. 1 and 2 show viscosity data obtained as a function of temperature and applied shear for two binder compositions of the invention.

FIG. 3 shows cut fabric according to the invention.

FIG. 4 shows cut fabric not according to the invention where cutting failed to follow the resin trace.

FIG. 5 shows cut fabric not according to the invention where a similar fabric sample to FIG. 3 was cut without use of resin trace.

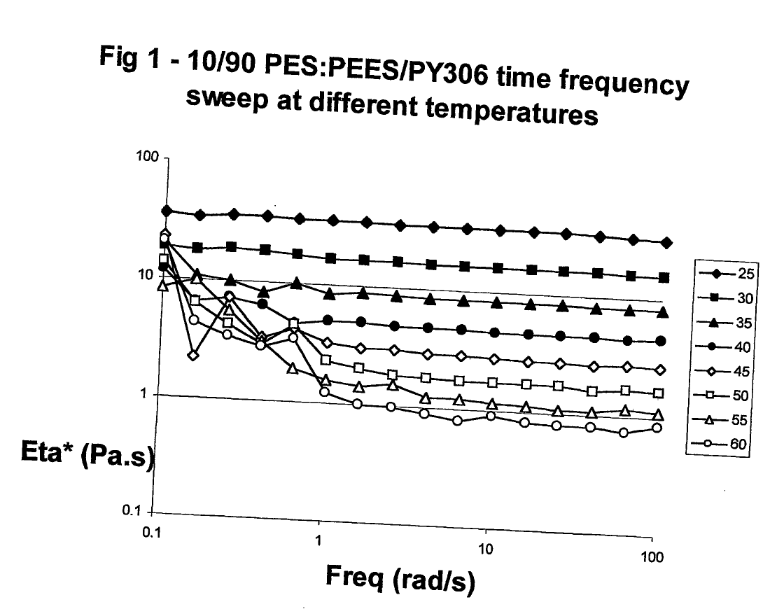

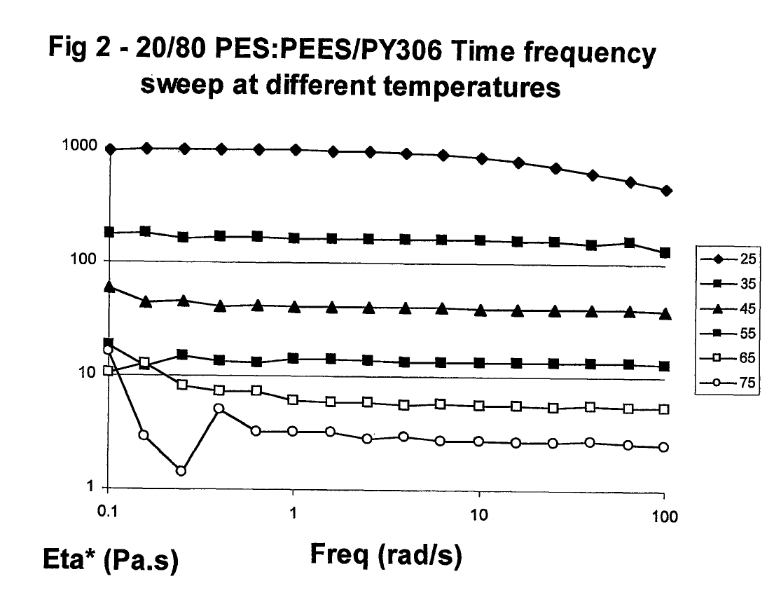

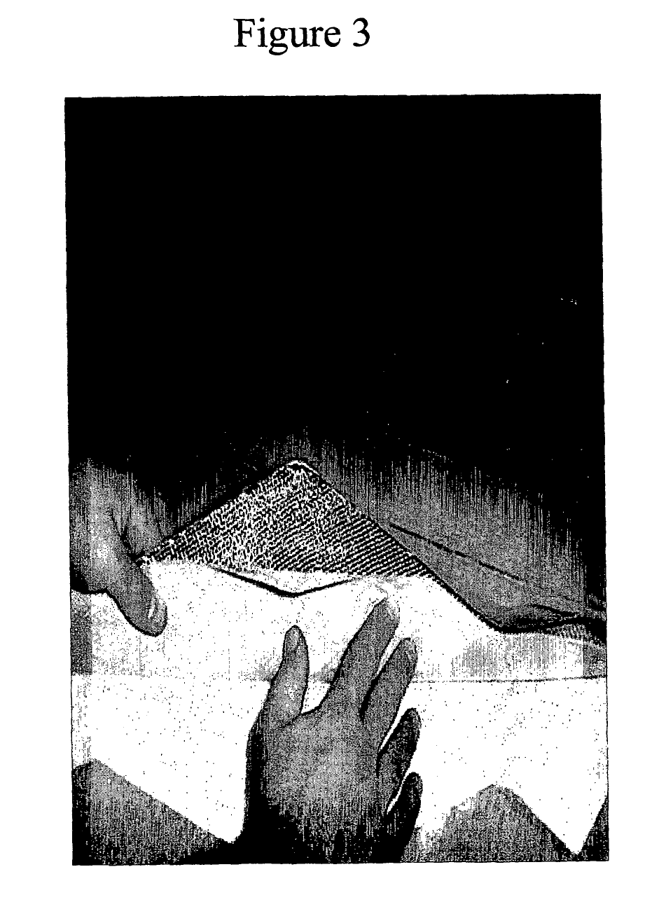

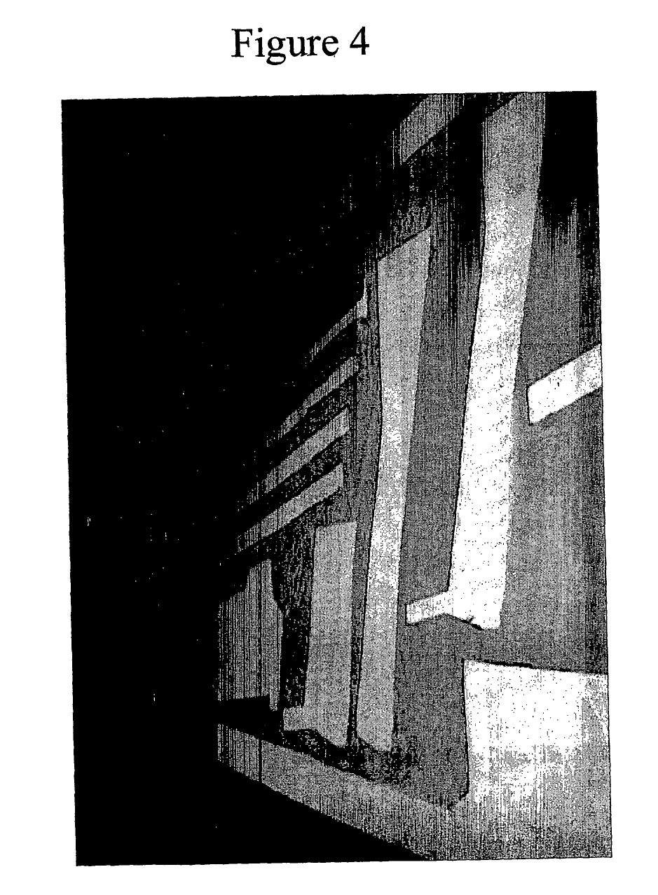

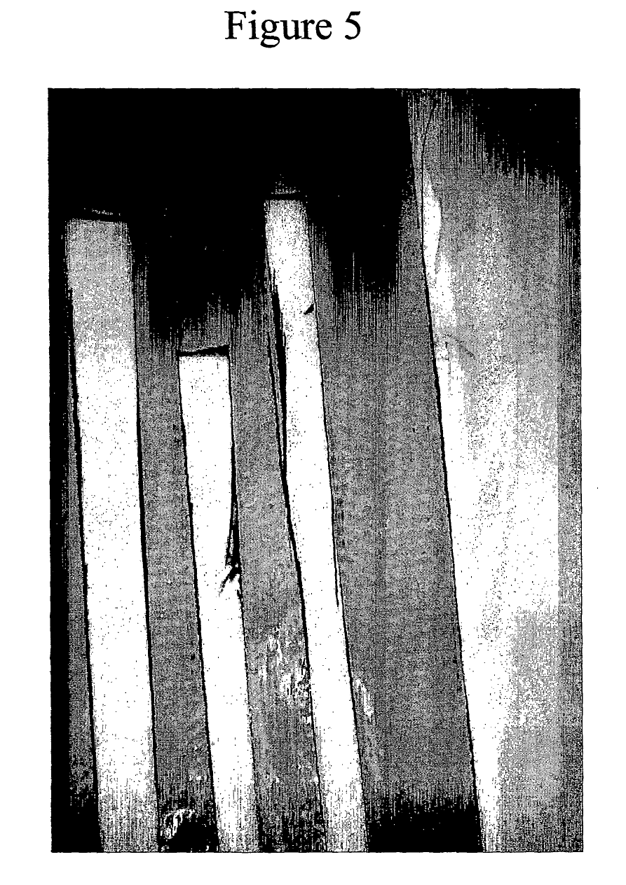

1. A method for preparing fabric for cutting comprising dispensing a trace of a resin composition on the fabric surface to provide a desired fabric cutting line for cutting the fabric along the trace of dispensed resin with cutting means, wherein the resin composition is stable under ambient or elevated temperature dispensing and cutting conditions and is characterised by a viscosity in the range 2000-1 Pa.s (18° C.) and tack or softening at ambient or elevated temperature in the range 20 to 130° C.

2. Method as claimed in claim 1 which comprises dispensing a composition comprising at least one resin component which is substantially unchanged after dispensing and cutting at dispensing and cutting conditions, and reverts to its resin form.

3. Method as claimed in any of claims 1 and 2 which comprises dispensing a resin composition in substantial absence of any curing agent, catalyst or cross linking agent which is activated by the dispensing or curing conditions.

4. Method as claimed in any of claims 1 to 3 which comprises laying up fabric for preparing and cutting on a suitable surface such as a cutting table, pretracing a shape to be cut with a suitable marker, dispensing resin composition as hereinbefore defined in any of claims 1 to 3 and cutting, or storing for later cutting.

5. Method as claimed in any of claims 1 to 4 wherein dispensing conditions comprises preheating the resin to a melt prior to dispensing, or heating in situ, to generate the resin in melt form; or dispensing the resin as a powder or film and heating to molten; or dispensing the resin as a spray.

6. Method as claimed in any of claims 1 to 5 wherein the resin is provided in or generated in melt form at ambient or elevated temperature in the range 20-130° C.

7. Method as claimed in any of claims 1 to 6 wherein cutting conditions comprises contact or incidence of the molten or cooled resin trace, by cutting means which generates insignificant energy and no temperature increase or which generates substantial energy causing localized temperature increase of the resin trace.

8. Method as claimed in any of claims 1 to 7 wherein fabric is any fabric which is prone to disassemble, disintegrate, or otherwise form rough or loose edges on dry cutting.

9. Method as claimed in any of claims 1 to 8 wherein fabric is any directional or non-directional aligned fibres in the form of a mesh, tow, scrim, braided or woven, knitted or non-crimped fabrics.

10. Composition as claimed in any of claims 1 to 9 for cutting fabric of density or aerial weight in the range of 200-2000 g/m².

11. Method as claimed in any of claims 1 to 10 for cutting fabric of thickness in the range 0.2-10 millimetres, either as a single fabric layer or a plurality of assembled layers.

12. Method as claimed in any of claims 1 to 11 wherein fabric comprises organic fibres selected from tough or stiff polymers or inorganic fibres selected from carbon, boron or glass fibres, alumina, zirconia, silicon carbide, ceramics and metals.

13. Method as claimed in any of claims 1 to 12 wherein the resin composition is characterised by temperature independent viscosity or partially dependent viscosity whereby viscosity is substantially unchanged or decreases in the range as hereinbefore defined in claim 1 both on heating to a resin melt, and on contact or incidence of the cutting means.

14. Method as claimed in any of claims 1 to 13 wherein the composition is suited for dispensing such that the resin permeates the fabric surface and optionally partially penetrates the fabric to a depth 0.1 to 4 mm, but is not able to contact the cutting surface.

15. Method as claimed in any of claims 1 to 13 wherein resin trace is of width in the range 0.5 to 20 mm.

16. Method for laying up a fabric prepared and cut according to the method of any of claims 1 to 15 with other layers of fabric and/or in a mould whereby residual tack from the cut edges assists in maintaining positioning of the fabric by non contaminating tack to the adjacent fabric layer(s) or mould surface.

17. Resin composition for use in a method for preparing fabrics for cutting as hereinbefore defined in any of claims 1 to 15 comprising at least one substantially stable resin characterised by viscosity in the range 2000-1 Pa.s (18° C.) and tack or softening at ambient and/or elevated temperature in the range 20 to 130° C.

18. Resin composition as claimed in claim 17 which is thermally and/or chemically stable such that it is substantially unchanged after subjecting to dispensing and cutting conditions, and reverts to its resin form, and comprises substantially no curing agent, catalyst or cross linking agent which would be activated at ambient or elevated temperature in the range 20 to 130° C.

19. Resin composition as claimed in any of claims 17 and 18 comprising a thermoplast resin component and a thermoset resin component in ratio 40:60-5:95.

20. Resin composition as claimed in claim 19 wherein the thermoplast resin component is selected from at least one of the group of polyaromatics such as polyaryl(thio)ethers and in particular polysulphones, heterocyclic aromatic polymers such as polyimides and polyetherimides, polyamides such as nylon, polyesters such as ethan-1,2-diol PET and PEN, polyurethanes such as thermoplastic polyurethane rubber, polyvinylalcohols and copolymers thereof.

21. Resin composition as claimed in claim 20 wherein the at least one polyaromatic comprises ether-linked and/or thioether-linked repeating units, the units being selected from the group consisting of
-(PhAPh)ₙ-
and optionally additionally
-(Ph)ₐ-
wherein A is SO₂ or CO, Ph is phenylene, n=1 to 2, a=1 to 4 and when a exceeds 1, said phenylenes are linked linearly through a single chemical bond or a divalent group other than -A- or are fused together directly or via a cyclic moiety such as a cycloalkyl group, a (hetero) aromatic group, or cyclic ketone, amide, amine, or imine, said at least one polyarylsulphone having reactive pendant and/or end groups.

22. Resin composition as claimed in claim 20 wherein the at least one polyaromatic comprises ether-linked repeating units, optionally additionally comprising thioether-linked repeating units, the units being selected from
-(PhSO₂Ph)ₙ-
and additionally
-(Ph)ₐ-
wherein Ph is phenylene, n=1 to 2 and can be fractional, a=1 to 3 and can be fractional and when a exceeds 1, said phenylenes are linked linearly through a single chemical bond or a divalent group other than —SO₂— or are fused together, provided that the repeating unit -(PhSO₂Ph)ₙ- is always present in said at least one polyarylsulphone in such a proportion that on average at least two of said units -(PhSO₂Ph)ₙ- are in sequence in each polymer chain present, said at least one polyarylsulphone having reactive pendant and/or end groups.

23. Composition as claimed in any of claims 20 to 22 wherein the at least one polyaromatic comprises polyether sulphone, preferably a combination of polyether sulphone and of polyether ether sulphone repeating units, in which the phenylene group is meta- or para- and is preferably para and wherein the phenylenes are linked linearly through a single chemical bond or a divalent group other than sulphone, or are fused together.

24. Composition as claimed in any of claims 21 to 23 wherein the units are:
XPhSO₂PhXPhSO₂Ph(“PES”) and I
X(Ph)ₐXPhSO₂Ph(“PEES”) II
where X is O or S and may differ from unit to unit; the ratio is I to II (respectively) preferably between 10:90 and 80:20, such as between 35:65 and 65:35.

25. Composition as claimed in any of claims 21 to 24 wherein reactive end groups comprise groups reactive with epoxide groups or with curing agent or with like groups on other polymer molecules, selected from groups providing active hydrogen especially OH, NH₂, NHR′ or —SH, where R′ is a hydrocarbon group containing up to 8 carbon atoms, or providing other cross-linking reactivity especially epoxy, (meth)acrylate, cyanate, isocyanate, acetylene or ethylene, as in vinyl, allyl or maleimide, anhydride, oxazaline and monomers containing unsaturation.

26. Composition as claimed in any of claims 20 to 25 wherein the number average molecular weight of the polyaromatic is in the range 2000 to 20000.

27. Composition as claimed in any of claims 19 to 26 wherein the thermoset resin component is selected from the group consisting of an epoxy resin, an addition-polymerisation resin, especially a bis-maleimide resin, a formaldehyde condensate resin, especially a formaldehyde-phenol resin, a cyanate resin, an isocyanate resin, a phenolic resin and mixtures of two or more thereof.

28. Composition as claimed in any of claims 19 to 27 comprising thermoplast polyaromatic comprising polyethersulphone: polyetherether sulphone in ratio 60:40-50:50 in combination with thermoset selected from cyanate ester, bismaleimide and epoxy in the range 20:80-5:95.

29. Method for the preparation of a resin composition as hereinbefore defined in any of claims 17 to 28 comprising admixing the thermoset and thermoplast resin components, optionally in the presence of solvent and/or warming to a temperature of up to 80° C.

30. Method as claimed in claim 29, wherein the composition is in resin form and any solvent is removed; or is in liquid or spray form and the resin compositions are suitably dissolved in a solvent; or is in film form, and the composition is suitably cast onto a release surface; or is in powder form, and the composition is suitably granulated and milled to appropriate particle size.

31. Method for selecting or blending a resin composition as claimed in any of claims 17 to 28 having desired viscosity and tack at ambient and/or elevated temperature, for dispensing on a given fabric and cutting by the method as hereinbefore defined in any of claims 1 to 15, comprising determining a required viscosity for penetration of the given fabric, with reference to fabric density (aerial weight) and/or thickness and selecting at least one resin component and a dispensing temperature with reference to viscosity-temperature data.

32. A dispensing cutting apparatus for use in a method for cutting dry fabrics as hereinbefore defined in any of claims 1 to 15 comprising a reservoir for resin composition as hereinbefore defined in any of claims 17 to 28, a nozzle for dispensing a trace of resin and a cutting means aligned to follow the resin trace.

33. Cut fabric cut by the method of any of claims 1 to 15 for storing or placing in a mould for subsequent processing into an article.

34. Method for dry fibre moulding comprising cutting a fabric using the method as hereinbefore defined in any of claims 1 to 15, placing in a mould, optionally contacting with a binder resin and injecting or infusing matrix resin wherein matrix resin comprises in combination or separately a thermoplast and thermosetting resin, typically in weight ratio 10:90-90:10, which may be the same as or different to the cutting binder used in the preparation of the cutting binder.

35. A preform or curable composition obtained with use of moulding method as hereinbefore defined in claim 34.

36. Method for curing a curable composition as hereinbefore defined in claim 35 comprising subjecting to elevated temperature and pressure for a period suitable to effect curing thereof.

37. Composite part obtained with use of the method of claim 36.

38. Cut fabric, preform, curable composition or composite part obtained with use of the methods and composition substantially as hereinbefore described and/or illustrated in the description and/or example.
